(19) United States
(12) Patent Application Publication
(10) Pub. No.: US 2019/0190861 A1
(43) Pub. Date: Jun. 20, 2019

(54) NOTIFICATIONS FOR UNAVAILABLE USERS OF A SOCIAL NETWORKING SYSTEM IMPLEMENTED USING A DATABASE SYSTEM

(71) Applicant: salesforce.com, inc., San Francisco, CA (US)

(72) Inventors: Noushad Nazmi, Dublin (IE); Evin Conway, Dublin (IE)

(21) Appl. No.: 15/841,879

(22) Filed: Dec. 14, 2017

(51) Int. Cl. H04L 12/58; H04L 29/08; G06F 3/048; H04W 4/08

(52) U.S. Cl. CPC H04L 51/043; H04L 51/32; H04W 4/08; G06F 3/048; H04L 67/306

(57) ABSTRACT

Disclosed are some implementations of systems, apparatus, methods and computer program products for providing notifications of unavailable users of a social networking system. Prior to sharing a message with a contact via a social networking system, a user may be notified of the unavailable status of the contact. In addition, backup contacts may be suggested so that the message may be shared with users who are available to respond.

### COPYRIGHT NOTICE

A portion of the disclosure of this patent document contains material, which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to database systems and techniques associated with social networking systems. More specifically, this patent document discloses techniques for using and maintaining data objects in a database system to identify appropriate contact records for sharing social media messages.

### BACKGROUND

“Cloud computing” services provide shared resources, software, and information to computers and other devices upon request. In cloud computing environments, software can be accessible over the Internet rather than installed locally on in-house computer systems. Cloud computing typically involves over-the-Internet provision of dynamically scalable and often virtualized resources. Technological details can be abstracted from the users, who no longer have need for expertise in, or control over, the technology infrastructure “in the cloud” that supports them.

Users today can communicate with one another using a variety of communication platforms and social networking systems. Through these channels, a user may compose a message and share the message with selected individuals or groups. Unfortunately the user is typically unaware of the availability of the individuals with whom the message is shared.

### BRIEF DESCRIPTION OF THE DRAWINGS

The included drawings are for illustrative purposes and serve only to provide examples of possible structures and operations for the disclosed systems, apparatus, methods and computer program products for leveraging and managing assessment environments in an assessment hub. These drawings in no way limit any changes in form and detail that may be made by one skilled in the art without departing from the spirit and scope of the disclosed implementations.

FIG. 1 shows a system diagram of an example of a database system 100 in a social networking environment, in accordance with some implementations.

FIG. 2A shows a graphical user interface (GUI) 200 generated on a display device of a client machine in a social network environment, in accordance with one or more implementations.

FIG. 2B shows a GUI 230 generated on a display device of a client machine in a social network environment, in accordance with one or more implementations.

FIG. 2C shows a GUI 260 generated on a display device of a client machine in a social network environment, in accordance with one or more implementations.

FIG. 2D shows a GUI 290 generated on a display device of a client machine in a social network environment, in accordance with one or more implementations.

FIG. 3 shows a GUI 300 generated on a display device of a client machine in a social network environment, in accordance with one or more implementations.

FIG. 4 shows an example of a method 400 for providing a notification of availability status of a user prior to sharing a social media message with the user, in accordance with some implementations.

FIG. 5A shows a block diagram of an example of an environment 10 in which an on-demand database service can be used in accordance with some implementations.

FIG. 5B shows a block diagram of an example of some implementations of elements of FIG. 5A and various possible interconnections between these elements.

FIG. 6A shows a system diagram of an example of architectural components of an on-demand database service environment 900, in accordance with some implementations.

FIG. 6B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Online social networks are increasingly becoming a common way to facilitate communication among people who can be recognized as users of a social networking system. Some online social networks can be implemented in various settings, including organizations, e.g., enterprises such as companies or business partnerships, academic institutions, or groups within such an organization. For instance, Chatter® can be used by employee users in a division of a business organization to share data, communicate, and collaborate with each other for various purposes.

Various implementations described or referenced herein are directed to different systems, apparatus, methods and computer-readable storage media for providing notifications for unavailable users of an online social network, also referred to herein as a social networking system. One example of an online social network is Chatter®, provided by salesforce.com, inc. of San Francisco, Calif. salesforce.com, inc. is a provider of social networking services, customer relationship management (CRM) services and other database management services. These various services can be provided in a cloud computing environment, for example, in the context of a multi-tenant database system. Different communities of users can be created and managed in such an environment without having to install software locally, that is, on computing devices of users accessing the communities. While the disclosed implementations are often described with reference to Chatter®, those skilled in the art should understand that the disclosed systems, apparatus, methods and computer-readable storage media can be implemented in the context of one or more other social networking systems, such as Facebook®, LinkedIn®, Twitter®, Google+®, Yammer® and Jive®.

A user of an online social network may share a message with another individual or group of individuals. For example, a user of Chatter® may share a message with an individual or group of individuals by “mentioning” the individual or group. For example, a user of Chatter® may mention an individual or group using @individual or @group. Unfortunately, when a user shares (e.g., posts) a message with another individual or group of individuals via an online social network, the user is typically unaware of the availability of the individual(s) prior to sharing the message.

Many systems enable individuals to configure their account to send a notification of their unavailability in response to the receipt of a message via the online social network. As a result, if one of the individuals with whom a message is shared is unavailable (e.g., out of office), the user that shared the message may receive a notification of the individual's unavailability. This notification is often referred to as an out-of-office (OOO) notification. Such a notification is typically sent on behalf of an unavailable individual only after the message is shared with the unavailable individual.

After the user receives the notification, the user must then manually identify a backup contact, return to the original message share and share the message with the backup contact in addition to the original individual(s). If the user wishes to add the full management chain of the unavailable individual, the user must typically identify and manually add each manager as a backup contact. For example, the user may add each backup contact using @backupcontact.

Unfortunately, the re-transmission of the original message can be confusing to the individuals who received the original message. Both the original and re-transmitted message will be present in their feeds, resulting in unnecessary clutter in the feeds. This can result in frustration and wasted time spent reading through multiple copies of the same message.

Some implementations of the disclosed systems, apparatus, methods and computer program products are configured for notifying users of the OOO status of a contact prior to sharing a message using an online social network. In addition, some implementations facilitate users in identifying and adding backup contacts to a message prior to sharing the message. By enabling a user to add a backup contact prior to sharing a message, the user can eliminate the sending of duplicate messages and resulting clutter in the feeds of recipients of the message.

By way of illustration, John is a Sales employee within an organization, Pyramid Construction, Inc. John is having an issue with the software that was recently updated. John decides to share a message with the head of the Information Technology (IT) group, Jane Johnson, to request assistance. John types @Johnson and the system presents contact identifiers that include “Johnson.” More particularly, the system presents the identifiers “Jane Johnson” and “Jeremy Johnson.” John hovers over the name “Jane Johnson” and a pop-up window including information pertaining to Jane Johnson is presented. The pop-window indicates that Jane Johnson is unavailable. In addition, the pop-up window suggests backup contact(s) who John can share the message with instead of or in addition to Jane Johnson.

John hovers over a name of the backup contact, Jane's manager Derek Donnelly, and a notification indicating that Derek Donnelly is unavailable is presented. John then hovers over the name of another backup contact, Derek's manager Mary Morrison, and a second pop-up window including an electronic mail (email) address of Mary Morrison is presented. In addition, the second pop-up window indicates the time zone in which Mary is located. John clicks on the email address of Mary Morrison and posts the message to share the message with Mary Morrison. The message is then displayed within an information feed of Mary Morrison.

In some online social networks, users can access one or more information feeds, which include information updates presented as items or entries in the feed. Such a feed item can include a single information update or a collection of individual information updates. A feed item can include various types of data including character-based data, audio data, image data and/or video data. An information feed can be displayed in a graphical user interface (GUI) on a display device such as the display of a computing device as described below. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, an online social network may allow a user to follow data objects in the form of records such as cases, accounts, or opportunities, in addition to following individual users and groups of users. The “following” of a record stored in a database allows a user to track the progress of that record. Updates to the record, also referred to herein as changes to the record, are one type of information update that can occur and be noted on an information feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be user-submitted messages or can otherwise be generated in response to user actions or in response to events. Examples of messages include: posts, comments, indications of a user's personal preferences such as “likes” and “dislikes”, updates to a user's status, uploaded files, and hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed, also referred to herein as the user's “wall,” which is one example of an information feed displayed on the user's profile page.

In some implementations, an information feed may be specific to a group of users of an online social network. For instance, a group of users may publish a news feed. Members of the group may view and post to this group feed in accordance with a permissions configuration for the feed and the group. Information updates in a group context can also include changes to group status information.

In some implementations, when data such as posts or comments input from one or more users are submitted to an information feed for a particular user, group, object, or other construct within an online social network, an email notification or other type of network communication may be transmitted to all users following the user, group, or object in addition to the inclusion of the data as a feed item in one or more feeds, such as a user's profile feed, a news feed, or a record feed. In some online social networks, the occurrence of such a notification is limited to the first instance of a published input, which may form part of a larger conversation. For instance, a notification may be transmitted for an initial post, but not for comments on the post. In some other implementations, a separate notification is transmitted for each such information update.

Some implementations of the disclosed systems, apparatus, methods and computer-readable storage media are configured to provide communities of users in an online social network. Such communities are to be differentiated from “groups” of users in Chatter®, described in greater detail below. That is, a community of users can exist as an entity apart from and in addition to any group or groups of such users in the social network, although some of the rights and restrictions provided to a community member may be the same or similar as those provided to a member of a group. In some implementations, a community can be defined as a secure space for different stake-holders of an organization, such as employees, customers and partners of the organization, to collaborate with one another by accessing shared data, interacting with community-centric tasks and business processes, and using conversational services such as chat sessions, feed-based communication, and private messaging. The community can be structured and maintained as a public or private space for users having different relationships with the organization, so the users can converse and collaborate in an effective manner. The users can be of different types, such as internal or external, and/or the users can have different roles, such as employee, customer or partner, with such types and roles defining a user's relationship with the organization. For example, a partner can be an entity external to an organization that sells services and/or provides support on behalf of an employee, who is an internal user of the organization. Multiple communities can be implemented, some affiliated with different organizations, and a user can navigate across the communities in a seamless fashion from the user's perspective.

Each community can be structured so a community leader, system administrator or other user having appropriate security clearance can define rules governing community membership and privileges governing: i) access and use of various community data, ii) the ability to take action and cause events to occur in relation to the community, and iii) the visibility of users to each other. These various privileges can be defined and customized at a granular level, for instance, with different access rights and restrictions configured on a per-user or per-type of user basis, on a per-data item or per-type of data basis, and/or on a per-action or per-type of action basis.

In some instances, a user can have different user profiles for different communities. In other instances, a user can have a primary user profile and can select which fields of the profile are to be exposed to each community of which the user is a member. In some implementations, a user's community profile has a child-parent relationship with the primary profile and is tailored to inherit data from selected fields of the primary profile.

In some instances, a community can be open, as is often the case with public communities, in that there are no or minimal restrictions on users to access data, initiate actions, and view other community members' profiles, regardless of user type or role with respect to an organization. Thus, in a public community, employees, customers and partners of an organization affiliated with the community can freely view community data and each other's profiles, follow the same objects, and converse using the same feeds, by virtue of being members of the same community.

In some implementations, a user can gain access to a community by logging in to the social networking system hosting the community. In other implementations, the same user identity (ID), such as a login name or email address assigned to a given user, can be used by a user to directly log in and thus gain access to a community, that is, without requiring the user to separately log in to the social networking system hosting the community.

In some implementations, full collaboration in a community is possible regardless of user type or role. Internal and external users can be provided with full access or the same level of restricted access to the same feeds available through the community, and such users can view each other's walls and follow each other.

In accordance with some implementations, a user is notified of the availability of an intended recipient of an unshared media message prior to sharing the media message via an online social network. The user can then send the media message to selected backup contact(s), as appropriate. The unavailability status and/or contact information may be provided for backup contacts over one or more management, group, or community levels.

In some implementations, the media message is presented within the feed of the recipients of the media message as designated by the user. Since the user can select backup contact(s) at the time that the media message is initially shared, the resulting feeds of the recipients and any other community members include only a single copy of the media message. Therefore, the feeds of the recipients and community members remain uncluttered by multiple copies of the same message.

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

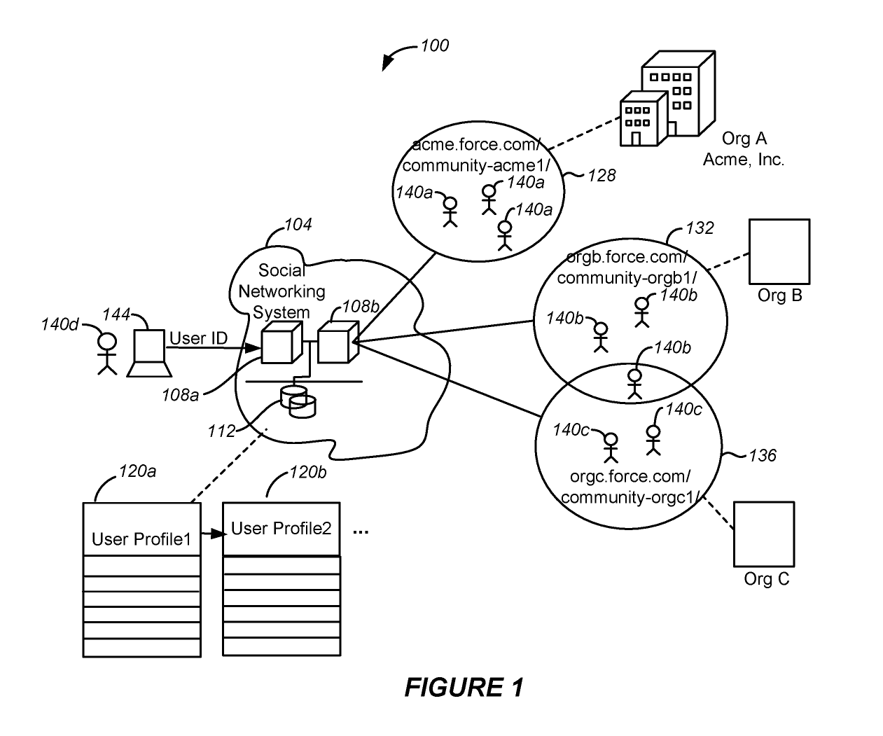

FIG. 1 shows a system diagram of an example of a database system 100 in a social networking environment, in accordance with some implementations. In FIG. 1, a social networking system 104 includes any number of computing devices such as servers 108a and 108b. The servers 108a and 108b are in communication with one or more storage mediums configured to store and maintain relevant data used to perform some of the techniques disclosed herein. In this example, the storage mediums include one or more databases 112, which may each include one or more tables that include data records. The databases 112 can maintain user profiles of users. Each profile can include information such as user ID, name, availability status indicator, contact/email address, phone number, and/or time zone. In addition, a profile can include an indication of one or more backup contacts that can be contacted in the event that the user is unavailable. For example, a backup contact can be an individual, a group or community. In some instances, a backup contact corresponds to an upper management level above the user. For example, the user may be an Information Technology (IT) group employee, while his or her primary backup contact is a manager of the IT group. A backup contact may be a member of the same group as the user or a different group from the user.

Individuals at any management level may have one or more associated backup contacts. A backup contact may be identified explicitly within the profile or implicitly via an identifier of or pointer to the backup contact's profile. For example, a first user having an associated user profile 120a can be linked to user profile 120b of his or her manager, as shown in FIG. 1. In some implementations, the databases 112 can maintain lists of IDs of users who are members of respective communities. By way of example, a “Community 1 User IDs” table in databases 112 can include a list of IDs of users who are members of Community 1, a “Community 2 User IDs” table can include a list of IDs of users who are members of Community 2, and so forth.

In addition, in some implementations, the databases 112 are configured to store privilege information identifying or specifying access rights and restrictions of users according to various attributes such as a specified user ID, type of user, role of user, type of community to which the user belongs, and/or a particular organization on behalf of which a community is maintained.

In FIG. 1, the social networking system servers 108 can be configured to maintain one or more communities of users such as communities 128, 132 and 136 by interacting with databases 112 to identify members of those communities and privileges of members of a given community. Any number of users such as users 140a, 140b and 140c can be serviced by social networking system 104. That is, any such users 140 can have user IDs and other relevant data such as user profiles maintained in social networking system 104. By leveraging the information stored in storage mediums such as databases 112, communities 128, 132 and 136 of such users 140 can be defined. Thus, in this example, the community 128 includes users 140a, community 132 includes users 140b, and community 136 includes users 140c and one of users 140b. Thus, one of the users 140b is a member of both communities 132 and 136. When any such users 140 log in directly to a community, bypassing login pages of social networking system 104, or log in via social networking system 104 using a suitable computing device such as a laptop, tablet or smartphone, such users can be allowed to access data and take one or more actions available through social networking system 104 as permitted by the relevant privilege information.

In accordance with various implementations, a user may make a request via servers 108a and 108b to share a message by posting a message on a community feed of a community of which the user is a member. In some implementations, a user may post a message on walls of other users. In addition, a user may follow users in association with a particular community. Users that are members of a particular community may be automatically registered as followers of other users within the community. Therefore, messages shared with the community may appear in the feed of each user within the community.

In FIG. 1, each of the communities 128, 132 and 136 is operated on behalf of a different organization. In this example, community 128 is operated on behalf of Org A, which in this example is Acme, Inc. For example, the users 140a in community 128 may be employees, customers and/or partners of Acme, Inc. By the same token, the community 132 is operated on behalf of Org B, which can be any type of organization as described in greater detail below. The community 136 is maintained on behalf of Org C. The various users in a given community can have different relationships with the organization on behalf of which the community is maintained. Thus, one or more of the users 140b can be an employee, customer or business partner of Org B. In this example, as mentioned above, one of the users 140b is a member of both communities 132 and 136. Thus, this user 140b could be an employee of Org B and a customer of Org C by way of example.

In FIG. 1, each community 128, 132 and 136 often has one or more pages of relevant community data maintained by social networking system 104, where such pages are accessible by a web browser program operating on a user's computing device. Thus, any user having access to a given community as defined by data stored in the privileges information can load part or all of such pages for display on the user's computing device. In the example of FIG. 1, a community's page or pages is accessible at a web domain such as a URL including an org value identifying the specific organization on behalf of which the community is maintained. This org value can be a character such as a letter, number, symbol, or string of characters identifying the specific organization with which the community is affiliated. Thus, pages or other social network data available to users 140a in community 128 can be accessed at a URL such as acme.force.com/community-acme1/. In this example of a URL, the string “acme” of “acme.force.com” can provide the org value, which identifies Acme, Inc. by name. In some instances, the “acme” of “community-acme1” can provide the org value identifying Acme, Inc. Acme, Inc. can have other web pages available to the general public, for example, at the URL acme.com, which is a different root domain than the acme.force.com address at which community-specific pages are provided.

The page or pages maintained by the social networking system 104 for community 132 can be accessed at the URL orgb.force.com/community-orgb1/. As in the example of Acme, Inc., the “orgb” of “orgb.force.com” or the “orgb” of “community-orgb1” can be the org value identifying Org B. One or more pages maintained on behalf of community 136 can similarly be accessed and identified with org values at the URL orgc.force.com/communityorgc1/.

When a user 140d directly logs in to a community using an appropriate login page at the community URL, and the user is identified as a member of a particular community, the web browser program on the user's computing device can be automatically routed to access a page at the URL specific to that user's community, such as acme.force.com/community-acme1/. For example, the page can include an information feed that includes messages shared by a member of that community via the social networking system. The user can choose to navigate through additional pages accessible via the community or communities to which the user belongs.

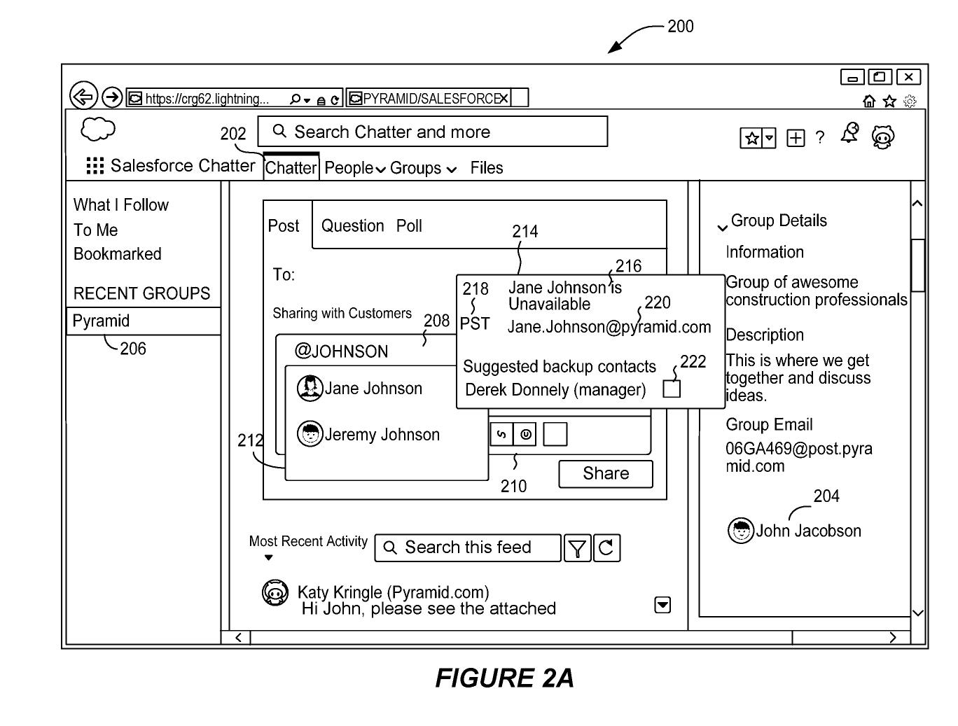

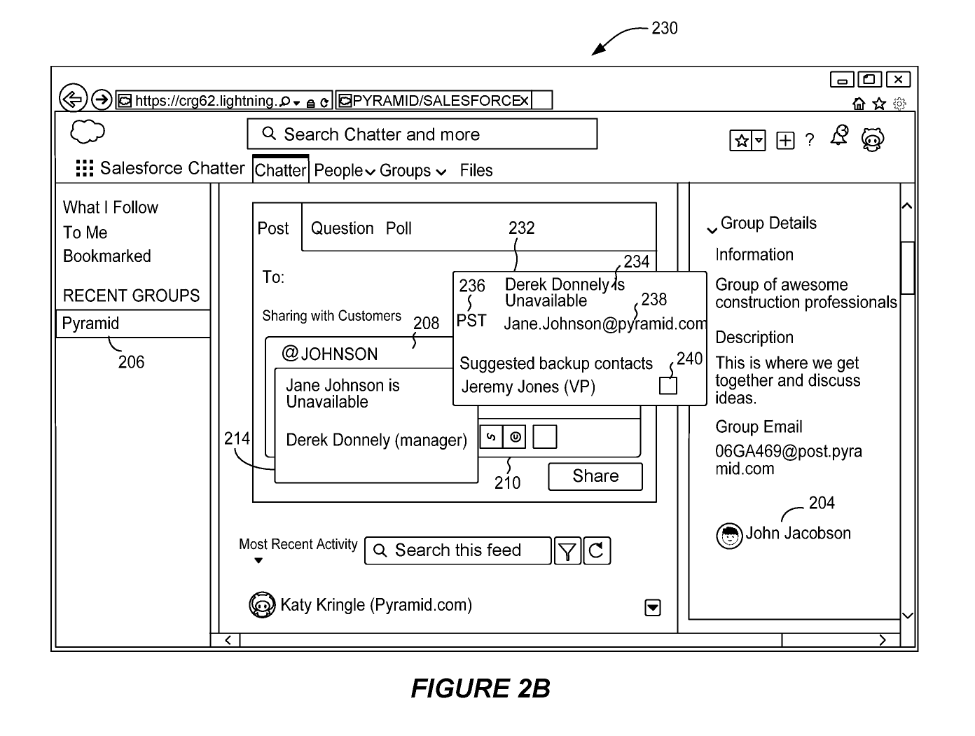

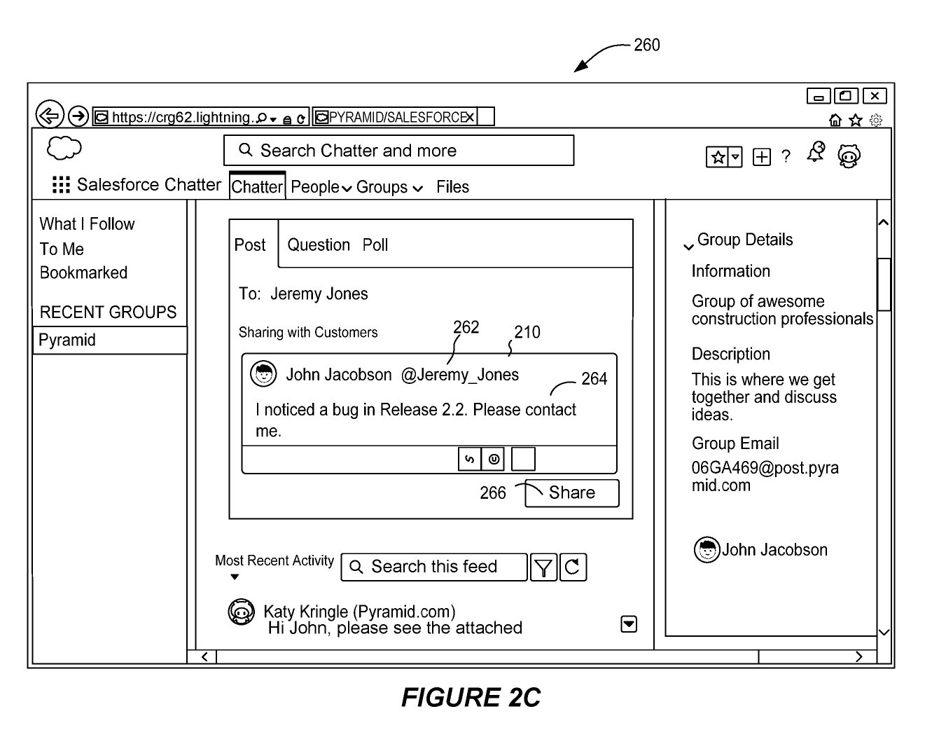

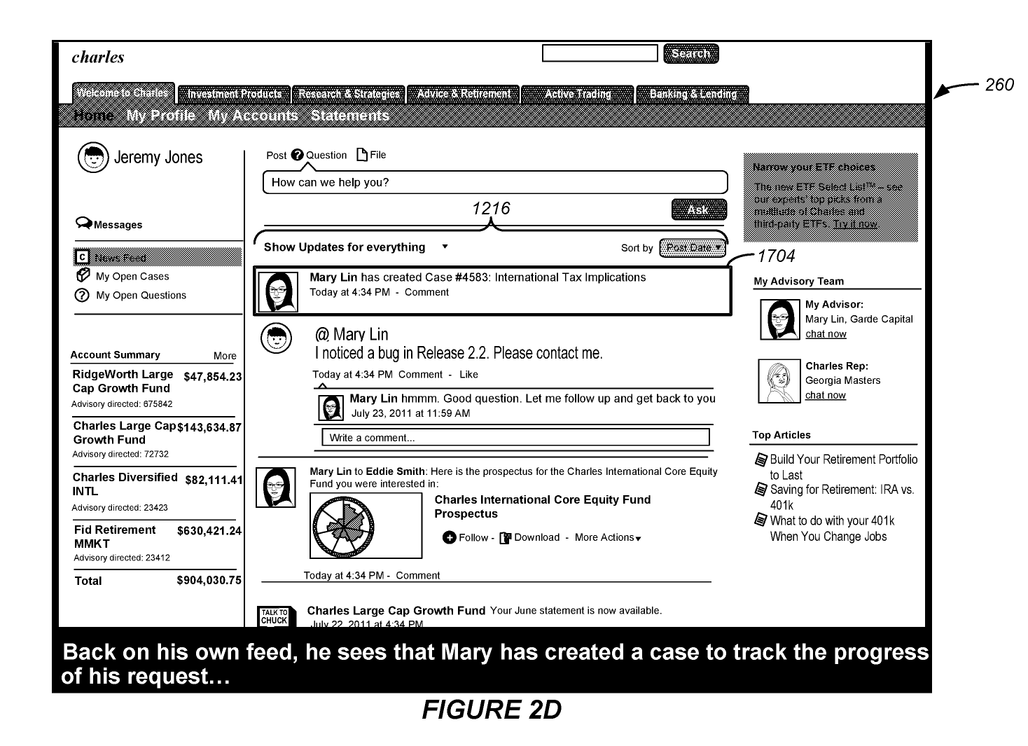

FIG. 2A shows a GUI 200 generated on a display device of a client machine in a social network environment, in accordance with one or more implementations. In this example, social network system Chatter® 202 can be used by users within a group or community to share data, communicate, and collaborate with each other for various purposes. In this example, user John Jacobson 204 is a Sales employee within an organization, Pyramid Construction, Inc. As shown in this example, John is a member of the group or community, Pyramid 206. John identified a bug in the software that was recently updated and decides to share a social media message with the head of the Information Technology (IT) group, Jane Johnson, to request assistance. The social media message can be composed prior to or after selection of recipients for the unshared social media message. The social networking system obtains an indication of an intended recipient of an unshared social media message. The indication of the intended recipient can include one or more letters of the recipient's first and/or last name. Alternatively, where the intended recipient is a group of users, the indication can include one or more letters of the name of the group. In some implementations, the indication of the intended recipient starts with a symbol such as “@”.

In this example, John types @Johnson as shown at 208 within user interface element 210. The system processes the indication of the intended recipient of the unshared social media message to identify one or more contacts. More particularly, the system identifies all possible contacts for whom the identifier contains the letters “Johnson.” For example, the identifier can include a name, username, etc.

The system provides a user interface element 212 for display at a client device of the user, where the user interface element includes a contact identifier for each of the possible contacts identified based upon the typed characters. Contacts identified solely based upon the typed characters may be referred to as primary contacts.

As shown in FIG. 2A, a user may interact with the user interface element 212 to select a particular contact. In some implementations, a user may click on a particular contact or associated user interface element (e.g., box or button) to select the contact as a recipient of an unshared media message. In various implementations, a user may select a particular contact (e.g., by hovering over the contact or associated user interface element) to obtain further contact information for that contact (e.g., via presentation of a further user interface element).

A user interface element can provide a suitable interface for presenting information to a user. In some implementations, a user interface element can enable a user to submit input to the system and/or request information from the system.

In this example, the user interface element 212 is a pop-up window. However, a user interface element may be presented in another manner or format. For example, the user interface element 212 may include a list, menu, window, panel, or other type of user interface. In this example, the pop-up window includes a list presenting suggested contacts including Jane Johnson and Jeremy Johnson. A user interface element may be used in a similar manner to enable a user to select a backup contact as a recipient of an unshared message or to obtain further information associated with the backup contact, as will be described in further detail below.

John hovers his mouse over the name “Jane Johnson” to select Jane Johnson and a user interface element such as pop-up window 214 including information pertaining to Jane Johnson is presented. More particularly, the pop-up window 214 can include an indication of the availability status of Jane Johnson. In this example, the pop-up window 214 indicates that Jane Johnson is unavailable (e.g., OOO) at 216. The pop-up window 214 can further include additional contact information 220 such as the contact's email address, Jane.Johnson@pyramid.com. As shown in this example, the pop-up window 214 can further indicate the contact's time zone 218. In addition, the pop-up window 214 suggests backup contact(s) who John can share the message with instead of or in addition to Jane Johnson. As shown in this example, the system suggests backup contact, Derek Donnelly, who is the direct manager of Jane Johnson. John can choose to share the media message with Derek Donnelly instead of or in addition to Jane Johnson, by clicking on the corresponding name or check box 222. In this example, a single backup contact is suggested to simplify the illustration. However, it is important to note that any number of backup contacts may be suggested for a particular contact.

When a new user interface element such as a pop-up window is presented, the prior user interface element may be eliminated from the display. For example, when the pop-up window 214 is presented, the window 210 may be eliminated from the display.

While the contact information is shown as presented in a pop-up window, it is important to note that the contact information for a selected contact can be presented in another form of user interface element. For example, the contact information may be presented via a menu, list, or other display format.

In the example shown in FIG. 2A, the backup contact is the direct manager of Jane. Thus, only first-tier management is presented as a backup contact in this example. However, it is important to note that additional tiers of management and other individuals or groups may also be presented as backup contacts, as will be described in further detail below. Each of the backup contacts is user-selectable. In accordance with various implementations, backup contact information associated with a backup contact may be presented in a similar fashion to contact information associated with a particular contact, as described above with reference to FIG. 2A. Thus, a given backup contact may have its own associated backup contacts for which information is presented in the event that the backup contact is unavailable.

FIG. 2B shows a GUI 230 generated on a display device of a client machine in a social network environment, in accordance with one or more implementations. As shown in FIG. 2B, John hovers over an identifier of the suggested backup contact, Derek Donnelly, and backup contact information pertaining to the suggested backup contact, Derek Donnelly is presented. In this example, the backup contact information is provided via a user interface element such as pop-up window 232. Pop-up window 232 indicates an availability status 234 of the backup contact. In addition, the pop-up window 232 may indicate the time zone 236 of the backup contact and an email address 238, Derek.Donnelly@pyramid.com.

In this example, the availability status 234 indicates that Derek Donnelly is unavailable. Thus, the pop-up window 232 further identifies a “second tier” backup contact, Jeremy Jones, who is a backup contact for Derek Donnelly. John can select the backup contact, Jeremy Jones, by interacting with a user interface element. For example, John can click on user interface element (e.g., check box) 240 to select Jeremy Jones as a recipient of the unshared media message. Since the backup contact, Derek Donnelly, is unavailable, John can hover over the identifier of the second-tier backup contact, Jeremy Jones to view associated contact information and identify further backup contacts, as described above with reference to FIG. 2A.

In this example, the user interface element 240 is a check box. However, a user interface element may be presented in another manner or format to enable a user to interact with the system. For example, a user interface element may include a button, hypertext link, tab, or bar.

Where a contact is available, the availability status may be implied. Alternatively, the availability status may explicitly indicate that the contact is available.

Once the user has selected a contact and/or backup contact, the user may post an unshared media message to share the message with the selected contact(s). FIG. 2C shows a GUI 260 generated on a display device of a client machine in a social network environment, in accordance with one or more implementations. In this example, the user has selected Jeremy Jones by clicking on check box 240. The contact address 262 (e.g., email address) is rendered within user interface element 210 and the user types a message 264 indicating the presence of a bug in the recent release. The user then clicks on Post/Share user interface element 266 and message 264 is shared with Jeremy Jones. FIG. 2D shows a GUI 290 generated on a display device of a client machine in a social network environment, in accordance with one or more implementations. As shown in FIG. 2D, the message that has been shared in FIG. 2C will be included in the feed of Jeremy Jones. In the event that Jeremy Jones is a member of the community, Pyramid, the shared message will also be included in the feed of other members of the community. However, since the message is not addressed to those other members, the other members will be aware that the message is merely informational and they do not need to take action on the message that is in their feeds.

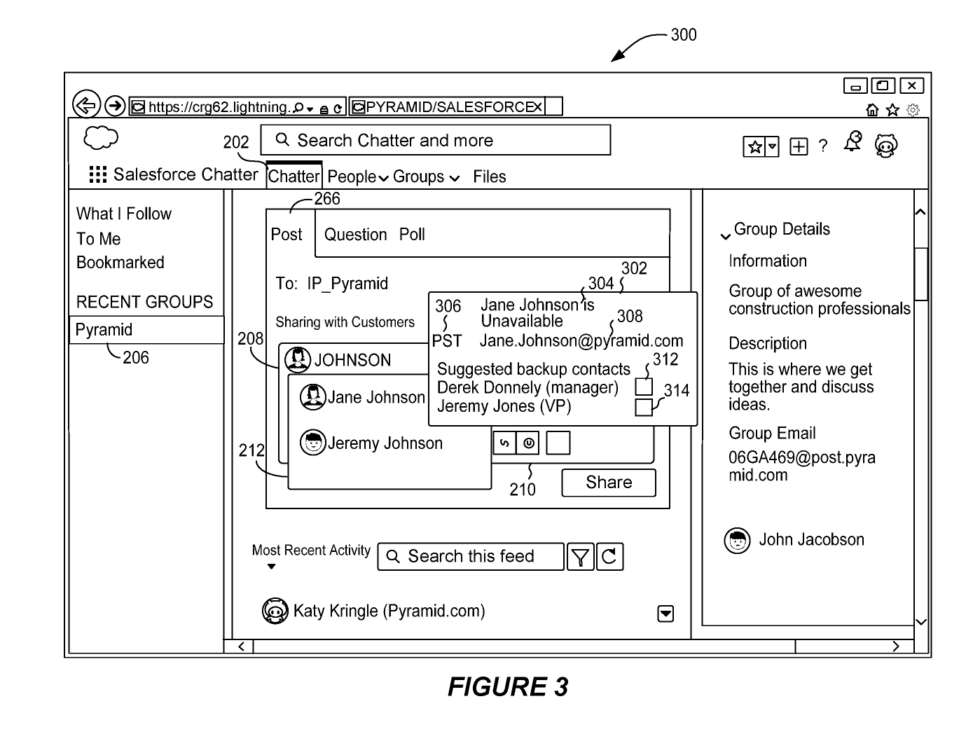

In the above-described implementations, backup contacts are presented in tiers such that only those direct backup contacts of the selected contact are rendered. In other implementations, backup contacts across multiple tiers are presented simultaneously for selection by the user, as will be described in further detail below with reference to FIG. 3.

FIG. 3 shows a GUI 300 generated on a display device of a client machine in a social network environment, in accordance with one or more implementations. In this example, John types @Johnson as shown at 208 with user interface element 210. The system processes the indication of the intended recipient of the unshared social media message to identify contacts.

The system provides a user interface element such as a pop-up window 212 for display at a client device of the user, where the user interface element includes a contact identifier for each of the contacts. As shown in this example, a list presents suggested contacts including Jane Johnson and Jeremy Johnson.

John hovers his mouse over the name “Jane Johnson” to select Jane Johnson and a user interface element such as pop-up window 302 including information pertaining to Jane Johnson is presented. More particularly, the pop-up window can include an indication of the availability status of Jane Johnson. In this example, the pop-up window 302 indicates that Jane Johnson is unavailable (e.g., OOO) at 304. The pop-up window 302 can further include additional information such as the contact's time zone 306 and contact information 308 such as the contact's email address, Jane.Johnson@pyramid.com. In addition, the pop-up window 302 suggests backup contact(s) who John can share the message with instead of or in addition to Jane Johnson.

In this example, the system suggests backup contacts, Derek Donnelly and Jeremy Jones. While Derek Donnelly is the direct manager of Jane Johnson, Jeremy Jones is the Vice President of the company. Thus, in this example, backup contacts across multiple management tiers are presented in a single graphical user interface element.

The user can subsequently select one or more of the backup contacts, e.g., by clicking on the selected backup contact. As shown in this example, John can choose to share the media message with Derek Donnelly and/or Jeremy Jones instead of or in addition to Jane Johnson, by clicking on check box 312 and/or 314, respectively. In some implementations, information pertaining to the selected backup contact may be presented via a further user interface element (e.g., pop-up window) when the user hovers over a backup contact, as described above.

In the implementations described above, the user can submit an indication that they have selected a particular contact to view their contact information. For example, when the user hovers over a particular contact, the contact information (e.g., availability, time zone, and/or contact address) is rendered. In other implementations, the contact information is presented in conjunction with the contact identifier (e.g., name) within the same user interface element.

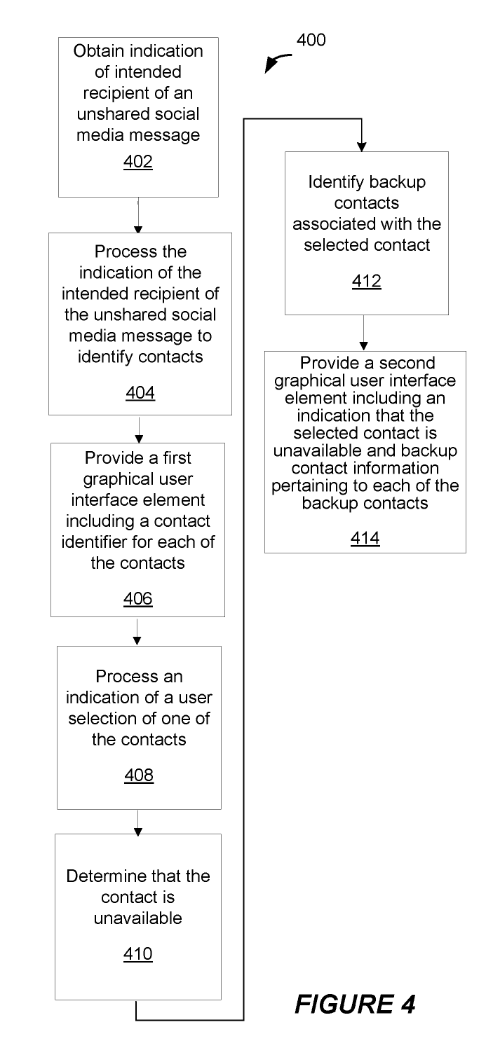

FIG. 4 shows an example of a method 400 for providing a notification of availability status of a user prior to sharing a social media message with the user, in accordance with some implementations. An indication of an intended recipient of an unshared social media message is received from a user via a social networking system at 402. For example, the user may mention an individual by typing “@Johnson.” The indication of the intended recipient of the unshared social media message is processed to identify one or more contacts at 404. More particularly, the system may identify those contacts that include the characters typed by the user (e.g., Johnson). In some implementations, the system identifies the contacts that exactly or approximately match the indication of the intended recipient. For example, where the user types “Johnson,” the system may identify those contacts that include the name “Johnson,” Jane Johnson and Jack Johnson. The database system provides a user interface element for display at a client device, where the user interface element includes a contact identifier for each of the contacts. In this example, the user interface element includes a list of contacts including Jane Johnson and Jack Johnson. Each of the contacts is associated with a corresponding user profile stored in a database of a database system.

An indication of a user selection of one of the contacts is received via the social networking system at 406. For example, the user can select the contact, Jane Johnson, by performing an action such as hovering over the name Jane Johnson within the list. An indication of the selection of the contact, Jane Johnson, is received by the social networking system.

Upon receiving the indication of the user selection of the contact, the system processes the indication of the user selection at 408 and provides information pertaining to the selected contact, as will be described in further detail below. In some implementations, the information that is provided depends, at least in part, on whether the selected contact is available. As will be described in further detail below, the system may provide an implicit or explicit indicator of the backup contact's availability. In some implementations, it may be implied that the user is available in the absence of an indicator to the contrary.

In accordance with various implementations, the system identifies the user profile of the selected contact and determines from the user profile of the selected contact or other resources associated with the selected contact (e.g., electronic calendar) whether the selected contact is available. For example, the selected contact may be on vacation and have configured the system to update his or her status as unavailable (e.g., out-of-office or on vacation) and relay his or her unavailability to other users. As another example, the selected contact may be in a meeting that is on his or her electronic calendar. In some implementations, the system updates the availability status in the user profile based upon resources external to the user profile (e.g., electronic calendars). The system can obtain the availability status from the user profile of the selected contact and ascertain from the availability status that the selected contact is unavailable.

Where the system determines from the user profile of the selected contact that the selected contact is unavailable at 410, the system identifies one or more backup contacts associated with the selected contact at 412 using the user profile of the selected contact. Each of the backup contacts is associated with a corresponding user profile stored in a database of the database system. The system may identify backup contact(s) that are explicitly identified within the user profile of the selected contact. For example, the system may identify the manager of the selected contact, Jane Johnson, from the user profile. In some implementations, the system may identify backup contact(s) that are implicitly identified within the user profile of the selected contact. For example, the user profile of the selected contact may include a pointer to a user profile of each backup contact of the selected contact. The system may access the user profile of each of the backup contacts to retrieve backup contact information pertaining to the corresponding backup contact. For example, the system may access a backup contact's user profile to ascertain their availability, time zone, contact address (e.g., email address), and/or phone number.

Responsive to processing the indication of the user selection of the one of the contacts, a user interface element may be provided for display at the client device at 414, where the user interface element includes an indication that the selected contact is unavailable and backup contact information pertaining to each of the backup contacts. For example, the user interface element may be presented in the form of a pop-up window, list, menu, or other type of graphical user interface element. The backup contact information for a backup contact can include an indication of one or more of: an availability status of the corresponding backup contact, a name of the corresponding backup contact, a title of the corresponding backup contact, a contact address such as an electronic mail (email) address of the corresponding backup contact, or a time zone of the corresponding backup contact. In some implementations, only the name of the backup contact is presented, and further backup contact information is provided upon user selection of the backup contact. For example, the user may hover over the name of a backup contact to view further contact information associated with the backup contact.

The backup contacts may correspond to individuals in one or more community or management levels within an organization. For example, the backup contacts may include the direct manager of the selected contact and/or upper level management.

In accordance with various implementations, each of the backup contacts is user selectable. The user can indicate a selection of one of the backup contacts by clicking or hovering over the selected backup contact. For example, the user can click on a name of one of the backup contacts or an associated user interface element to select the backup contact as a recipient for an unshared media message. As another example, the user can hover over the name of one of the backup contacts to view further information associated with the backup contact.

In some implementations, the system processes an indication of the user selection, received via the social network system, of one of the backup contacts. For example, the user may hover over the name of one of the backup contacts. The system accesses the user profile of the selected backup contact to retrieve backup contact information pertaining to the selected backup contact. Responsive to processing the indication of the user selection of the one of the backup contacts, backup contact information for the selected backup contact is provided for display at the client device. For example, the system may present information via a graphical user interface element such as a menu, list, or pop-up window. The information can include contact information such as email address and/or phone number, an indication of the time zone in which the backup contact is situated, and/or title. In addition, the system may provide an implicit or explicit indicator of the backup contact's availability. It may be implied that the user is available in the absence of an indicator to the contrary.

The system may determine from the user profile of the selected backup contact that the selected backup contact is unavailable. For example, the system may ascertain the backup contact's availability status from the corresponding user profile. Where the backup contact's availability status indicates that the backup contact is unavailable, the system may provide for display at the client device an indication that the backup contact is unavailable and information pertaining to backup contacts for the unavailable backup contact, as described above. Thus, the process may repeat to present an indication of the availability of a selected backup contact and backup contact information for backup contacts of the backup contact.

In the above-described implementations, backup contact information is presented in the event that a selected contact is unavailable. In other implementations, backup contact information is presented even where a selected contact is available. This enables a user who is aware of an upcoming vacation of the selected contact to easily identify backup contacts.

In some implementations, backup contact information for multiple backup levels (e.g., management levels) is presented within a single user interface element (e.g., pop-up window). The backup contact information for a given level may be presented independent of the availability of the lower level contact. Alternatively, the backup contact information for a given level may be presented solely if the lower level contact is unavailable.

Some but not all of the techniques described or referenced herein are implemented using or in conjunction with a social networking system. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, CRM services and other database management services, any of which can be accessed and used in conjunction with the techniques disclosed herein in some implementations. In some but not all implementations, these various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, LinkedIn®, Twitter®, Google+®, Yammer® and Jive® by way of example only.

Some social networking systems can be implemented in various settings, including organizations. For instance, a social networking system can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail below.

In some social networking systems, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a GUI on a display device such as the display of a computing device as described below. The information updates can include various social network data from various sources and can be stored in a database system. In some but not all implementations, the disclosed methods, apparatus, systems, and computer program products may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail below, allows a user to track the progress of that record when the user is subscribed to the record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be social media messages submitted by a user or can be otherwise generated in response to user actions or in response to events. Examples of social media messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned below, the data can include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “information feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) refers to an item of information such as a post submitted by a user, which can be presented in the feed. Feed items of information about a user can be presented in a user's profile feed of the database, while feed items of information about a record can be presented in a record feed of the database, by way of example. A profile feed and a record feed are examples of different information feeds. A second user following a first user and a record can receive the feed items associated with the first user and the record for display in the second user's news feed, which is another type of information feed. In some implementations, the feed items from any number of followed users and records can be combined into a single information feed of a particular user.

As examples, a feed item can be a message, such as a user-generated post of text data, or a feed tracked update to a record or profile, such as a change to a field of the record. Feed tracked updates are described in greater detail below. A feed can be a combination of messages and feed tracked updates. Messages include text created by a user, and may include other data as well. Examples of messages include posts, user status updates, and comments. Messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a GUI, for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group. In one implementation, there is only one status for a record.

In some implementations, a comment can be made on any feed item. In some implementations, comments are organized as a list explicitly tied to a particular feed tracked update, post, or status update. In some implementations, comments may not be listed in the first layer (in a hierarchical sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Social media messages and other types of feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and social media messages, such as posts, comments, likes, etc., can define group conversations and change over time.

An “entity feed” or “record feed” generally refers to a feed of feed items about a particular record in the database. Such feed items can include feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

Some non-limiting examples of systems, apparatus, and methods are described below for implementing database systems and enterprise level social networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

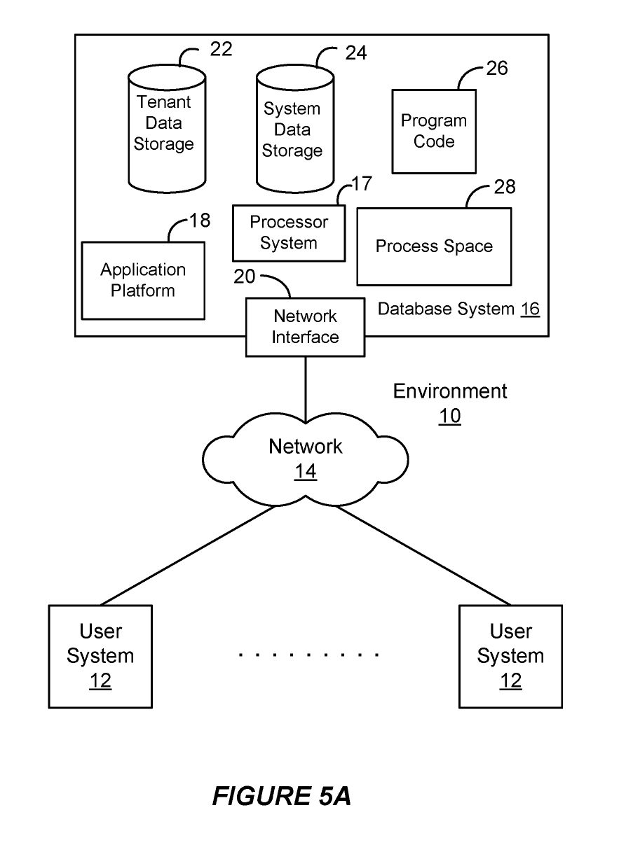

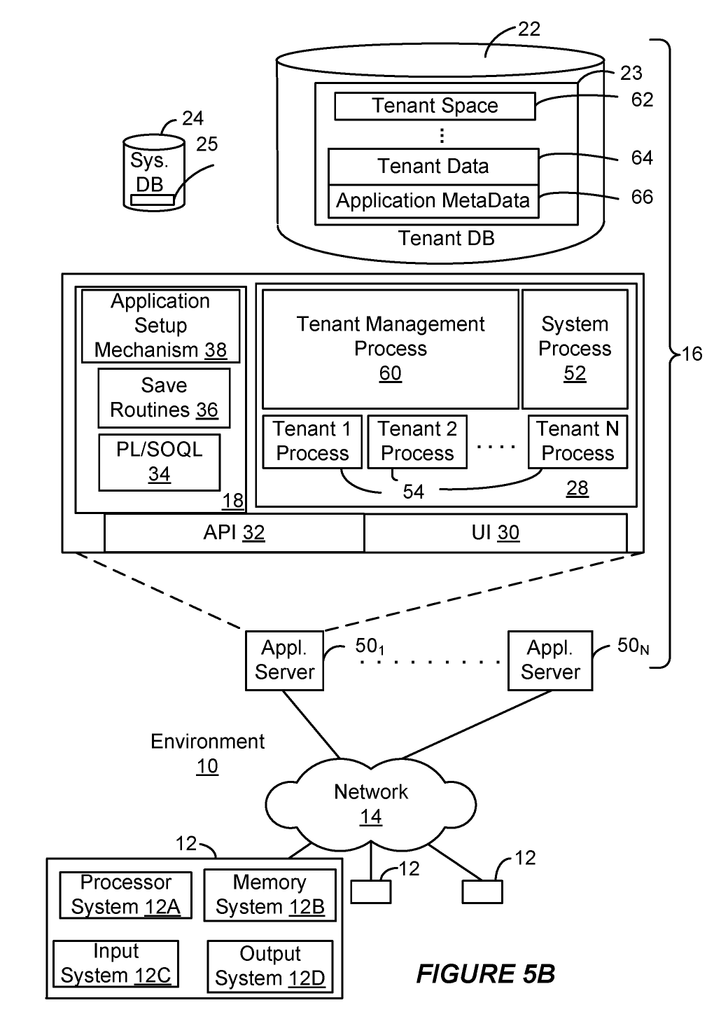

FIG. 5A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 5A (and in more detail in FIG. 5B) user systems 12 might interact via a network 14 with an on-demand database service, which is implemented in the example of FIG. 5A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 5A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 5A and 5B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 5A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 5B shows a block diagram of an example of some implementations of elements of FIG. 5A and various possible interconnections between these elements. That is, FIG. 5B also illustrates environment 10. However, in FIG. 5B elements of system 16 and various interconnections in some implementations are further illustrated. FIG. 5B shows that user system 12 may include processor system 12A, memory system 12B, input system 12C, and output system 12D. FIG. 5B shows network 14 and system 16. FIG. 5B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 5A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 5B, system 16 may include a network interface 20 (of FIG. 5A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

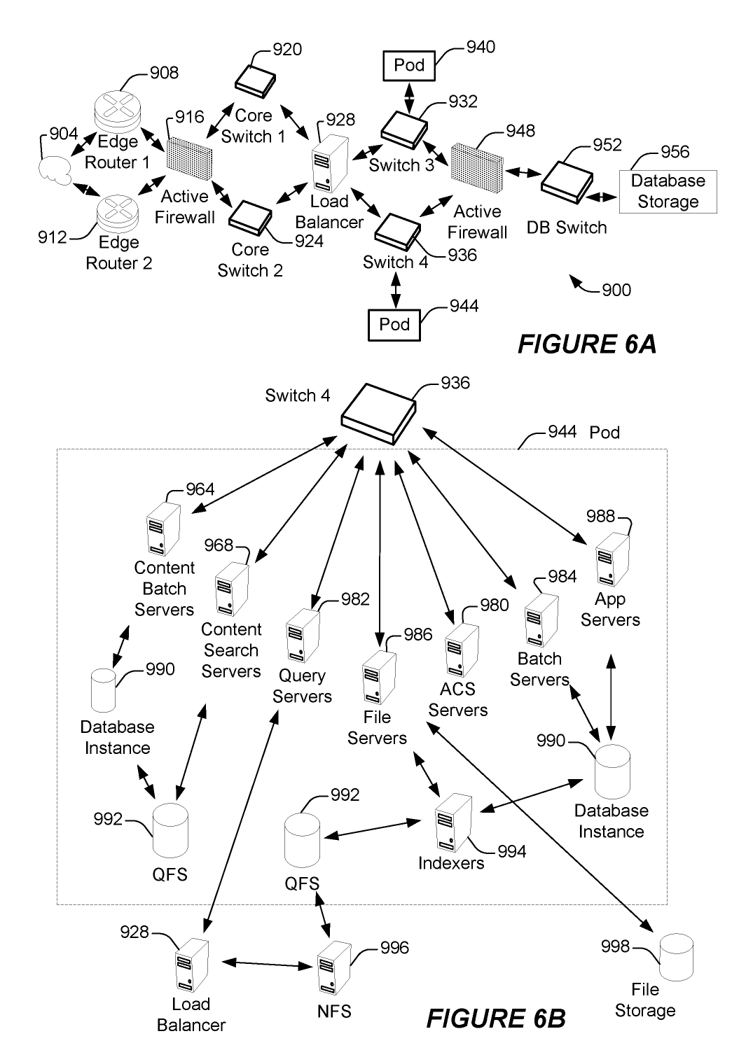

FIG. 6A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 6A and 6B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 6A and 6B, some implementations of an on-demand database service environment may include anywhere from one to many devices of each type. Also, the on-demand database service environment need not include each device shown in FIGS. 6A and 6B, or may include additional devices not shown in FIGS. 6A and 6B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 6B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 6A and 6B.

FIG. 6B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

In some implementations, one or more application servers or other servers described above with reference to FIGS. 5A and 5B include a hardware and/or software framework configurable to execute procedures using programs, routines, scripts, etc. Thus, in some implementations, one or more of application servers 50₁-50_{N} of FIG. 5B can be configured to initiate performance of one or more of the operations described above by instructing another computing device to perform an operation. In some implementations, one or more application servers 50₁-50_{N} carry out, either partially or entirely, one or more of the disclosed operations. In some implementations, app servers 988 of FIG. 6B support the construction of applications provided by the on-demand database service environment 900 via the pod 944. Thus, an app server 988 may include a hardware and/or software framework configurable to execute procedures to partially or entirely carry out or instruct another computing device to carry out one or more operations disclosed herein. In alternative implementations, two or more app servers 988 may cooperate to perform or cause performance of such operations. Any of the databases and other storage facilities described above with reference to FIGS. 5A, 5B, 6A and 6B can be configured to store lists, articles, documents, records, files, and other objects for implementing the operations described above. For instance, lists of available communication channels associated with share actions for sharing a type of data item can be maintained in tenant data storage 22 and/or system data storage 24 of FIGS. 5A and 5B. By the same token, lists of default or designated channels for particular share actions can be maintained in storage 22 and/or storage 24. In some other implementations, rather than storing one or more lists, articles, documents, records, and/or files, the databases and other storage facilities described above can store pointers to the lists, articles, documents, records, and/or files, which may instead be stored in other repositories external to the systems and environments described above with reference to FIGS. 5A, 5B, 6A and 6B.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (ROM) devices and random access memory (RAM) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system comprising:
a database system implemented using a server system, the database system configurable to cause:
obtaining, via a social networking system, an indication of an intended recipient of an unshared social media message;
processing the indication of the intended recipient of the unshared social media message to identify one or more contacts;
providing a first user interface element for display at a client device, the first user interface element including a contact identifier for each of the contacts, each of the contacts being associated with a corresponding user profile stored in a database of the database system;
processing an indication of a user selection of one of the contacts received via the social networking system;
determining from the user profile of the selected contact that the selected contact is unavailable;
identifying one or more backup contacts associated with the selected contact using the user profile of the selected contact, each of the backup contacts being associated with a corresponding user profile stored in a database of the database system; and
responsive to processing the indication of the user selection of the one of the contacts, providing a second user interface element for display at the client device, the second user interface element including an indication that the selected contact is unavailable and backup contact information pertaining to each of the backup contacts, each of the backup contacts being user selectable.

2. The system of claim 1, the database system being further configurable to cause:
determining from the user profile of a particular one of the backup contacts that the particular one of the backup contacts is unavailable; and
providing for display at the client device an indication that the particular one of the backup contacts is unavailable.

3. The system of claim 1, the backup contact information pertaining to each of the backup contacts comprising an indication of one or more of:
an availability status of the corresponding backup contact;
a name of the corresponding backup contact;
a title of the corresponding backup contact;
an electronic mail (email) address of the corresponding backup contact; or
a time zone of the corresponding backup contact.

4. The system of claim 1, the database system being further configurable to cause:
identifying one or more backup contacts using the user profile of the selected contact;
accessing the user profile of each of the backup contacts to retrieve backup contact information pertaining to the corresponding backup contact;
wherein the second user interface element further includes the retrieved backup contact information for each of the backup contacts, the backup contact information for each of the backup contacts including an email address of the corresponding backup contact and an indication of an availability status of the corresponding backup contact.

5. The system of claim 1, the database system being further configurable to cause:
processing an indication of a user selection, received via the social networking system, of one of the backup contacts;
accessing the user profile of the selected backup contact to retrieve backup contact information pertaining to the selected backup contact; and
responsive to processing the indication of the user selection of the one of the backup contacts, providing the backup contact information pertaining to the selected backup contact.

6. The system of claim 5, the backup contact information pertaining to each of the backup contacts comprising an indication of one or more of:
an availability status of the corresponding backup contact;
a name of the corresponding backup contact;
a title of the corresponding backup contact;
an electronic mail (email) address of the corresponding backup contact; or
a time zone of the corresponding backup contact.

7. The system of claim 1, wherein the backup contacts include two or more backup contacts across one or more management levels within an organization.

8. A computer program product comprising computer-readable program code capable of being executed by one or more processors when retrieved from a non-transitory computer-readable medium, the program code comprising computer-readable instructions configurable to cause:
obtaining, via a social networking system, an indication of an intended recipient of an unshared social media message;
processing the indication of the intended recipient of the unshared social media message to identify one or more contacts;
providing a first user interface element for display at a client device, the first user interface element including a contact identifier for each of the contacts, each of the contacts being associated with a corresponding user profile stored in a database of a database system;
processing an indication of a user selection of one of the contacts received via the social networking system;
determining from the user profile of the selected contact that the selected contact is unavailable;
identifying one or more backup contacts associated with the selected contact using the user profile of the selected contact, each of the backup contacts being associated with a corresponding user profile stored in a database of the database system; and
responsive to processing the indication of the user selection of the one of the contacts, providing a second user interface element for display at the client device, the second user interface element including an indication that the selected contact is unavailable and backup contact information pertaining to each of the backup contacts, each of the backup contacts being user selectable.

9. The computer program product of claim 8, the program code comprising instructions further configured to cause:
determining from the user profile of a particular one of the backup contacts that the particular one of the backup contacts is unavailable; and
providing for display at the client device an indication that the particular one of the backup contacts is unavailable.

10. The computer program product of claim 8, the backup contact information pertaining to each of the backup contacts comprising an indication of one or more of:
an availability status of the corresponding backup contact;
a name of the corresponding backup contact;
a title of the corresponding backup contact;
an electronic mail (email) address of the corresponding backup contact; or
a time zone of the corresponding backup contact.

11. The computer program product of claim 8, the program code comprising instructions further configured to cause:
identifying one or more backup contacts using the user profile of the selected contact;
accessing the user profile of each of the backup contacts to retrieve backup contact information pertaining to the corresponding backup contact;
wherein the second user interface element further includes the retrieved backup contact information for each of the backup contacts, the backup contact information for each of the backup contacts including an email address of the corresponding backup contact and an indication of an availability status of the corresponding backup contact.

12. The computer program product of claim 8, the program code comprising instructions further configured to cause:
processing an indication of a user selection, received via the social networking system, of one of the backup contacts;
accessing the user profile of the selected backup contact to retrieve backup contact information pertaining to the selected backup contact; and
responsive to processing the indication of the user selection of the one of the backup contacts, providing the backup contact information pertaining to the selected backup contact.

13. The computer program product of claim 12, the backup contact information pertaining to each of the backup contacts comprising an indication of one or more of:
an availability status of the corresponding backup contact;
a name of the corresponding backup contact;
a title of the corresponding backup contact;
an electronic mail (email) address of the corresponding backup contact; or
a time zone of the corresponding backup contact.

14. The computer program product of claim 8, wherein the backup contacts include two or more backup contacts across one or more management levels within an organization.

15. A method, comprising:
obtaining, via a social networking system, an indication of an intended recipient of an unshared social media message;
processing the indication of the intended recipient of the unshared social media message to identify one or more contacts;
providing a first user interface element for display at a client device, the first user interface element including a contact identifier for each of the contacts, each of the contacts being associated with a corresponding user profile stored in a database of a database system;
processing an indication of a user selection of one of the contacts received via the social networking system;
determining from the user profile of the selected contact that the selected contact is unavailable;
identifying one or more backup contacts associated with the selected contact using the user profile of the selected contact, each of the backup contacts being associated with a corresponding user profile stored in a database of the database system; and
responsive to processing the indication of the user selection of the one of the contacts, providing a second user interface element for display at the client device, the second user interface element including an indication that the selected contact is unavailable and backup contact information pertaining to each of the backup contacts, each of the backup contacts being user selectable.

16. The method of claim 15, further comprising:
determining from the user profile of a particular one of the backup contacts that the particular one of the backup contacts is unavailable; and
providing for display at the client device an indication that the particular one of the backup contacts is unavailable.

17. The method of claim 15, the backup contact information pertaining to each of the backup contacts comprising an indication of one or more of:
an availability status of the corresponding backup contact;
a name of the corresponding backup contact;
a title of the corresponding backup contact;
an electronic mail (email) address of the corresponding backup contact; or
a time zone of the corresponding backup contact.

18. The method of claim 15, further comprising:
identifying one or more backup contacts using the user profile of the selected contact;
accessing the user profile of each of the backup contacts to retrieve backup contact information pertaining to the corresponding backup contact;
wherein the second user interface element further includes the retrieved backup contact information for each of the backup contacts, the backup contact information for each of the backup contacts including an email address of the corresponding backup contact and an indication of an availability status of the corresponding backup contact.

19. The method of claim 15, further comprising:
processing an indication of a user selection, received via the social networking system, of one of the backup contacts;
accessing the user profile of the selected backup contact to retrieve backup contact information pertaining to the selected backup contact; and
responsive to processing the indication of the user selection of the one of the backup contacts, providing the backup contact information pertaining to the selected backup contact.

20. The method of claim 19, the backup contact information pertaining to each of the backup contacts comprising an indication of one or more of:
an availability status of the corresponding backup contact;
a name of the corresponding backup contact;
a title of the corresponding backup contact;
an electronic mail (email) address of the corresponding backup contact; or
a time zone of the corresponding backup contact.
